(19) United States
(12) Patent Application Publication
(10) Pub. No.: US 2015/0086307 A1
(43) Pub. Date: Mar. 26, 2015

(54) CONTAINER SYSTEM FOR HYDRAULIC FRACTURING PROPPANTS

(71) Applicant: Timothy Stefan, Bozeman, MT (US)

(72) Inventor: Timothy Stefan, Bozeman, MT (US)

(21) Appl. No.: 14/495,301

(22) Filed: Sep. 24, 2014

Related U.S. Application Data
(60) Provisional application No. 61/882,334, filed on Sep. 25, 2013.

(51) Int. Cl. B65D 88/62; B65G 65/30

(52) U.S. Cl. CPC B65D 88/62; B65G 65/30
USPC 414/304; 414/808; 414/802; 220/601; 220/666

(57) ABSTRACT

Described herein is an improved container for storing, shipping, and dispensing proppant materials used in hydraulic fracturing operations. The container systems incorporate stretchable hopper structures in the container. The hopper expands and contracts responsive to the amount of proppant material held in the container. When the container is filled with a sufficient amount of proppant, the hopper stretches to expand the storage volume. When the sufficient amount of proppant material is dispensed from the container, the hopper contracts to lift and dispense the container contents.

### PRIORITY

The present non-provisional patent application claims benefit from U.S. Provisional patent application having Ser. No. 61/882,334, filed on Sep. 25, 2013, by Tim Stefan, and titled CONTAINER SYSTEM FOR HYDRAULIC FRACTURING PROPPANTS, wherein the entirety of said provisional patent application is incorporated herein by reference.

### FIELD OF THE INVENTION

The present invention is in the field of container systems that are used to store, ship, and dispense hydraulic fracturing proppants. More specifically, the present invention relates to such container systems fitted with a stretchable hopper that expands and contracts responsive to the amount of proppant material held by the container system.

### BACKGROUND OF THE INVENTION

Hydraulic fracturing encompasses techniques for recovering oil from oilfields. Hydraulic fracturing also is referred to as fracking. In a typical process fluid is pumped at high pressure from the surface of an oil well down through a wellbore. The fluid is often an abrasive slurry comprising a fluid phase and one or more proppants dispersed in the fluid phase. The slurry is pumped to targeted regions to help create and maintain fractures within the underlying hydrocarbon formations.

The fracking fluid often is aqueous. A hydraulic fracturing proppant often is a solid material, typically sand, treated sand, man-made ceramic materials, or combinations of these, that are resistant to fracturing under high pressure and help to keep an induced hydraulic fracture open during or following a fracturing treatment. Proppants often are added to a fracking fluid which may vary in composition depending on the type of fracturing used.

Proppants desirably are permeable or permittive to gas under high pressures. Accordingly, the interstitial space between particles should be sufficiently large to allow such permeability. Yet, a proppant desirably has sufficient mechanical strength to withstand closure stresses to hold fractures open after the fracturing pressure is withdrawn. Large mesh proppants have greater permeability than small mesh proppants at low closure stresses, but could mechanically fail (e.g. get crushed) and produce very fine particulates (“fines”) at high closure stresses such that smaller-mesh proppants overtake large-mesh proppants in permeability after a certain threshold stress. Sand and treated sand are common proppant materials. Others include ceramic particles, glass, sintered bauxite, combinations of these, and the like.

In a typical hydraulic fracturing methodology, proppant materials are harvested and/or created at one location and then shipped to an oilfield to carry out fracking operations. This requires strategies to store, ship, and dispense the proppant material. Conventional strategies involve the use of large, rugged containers that hold substantial quantities of proppant materials. Because proppants such as sand are quite dense, the containers must be rugged and robust enough to support tons of material. Conventional containers suffer from significant disadvantages.

FIG. 1 shows a conventional container 10 that is used to store and dispense hydraulic fracturing proppants. Container 10 includes rigid body 12 having sides 14 and floor 16. A lid 18 can be opened and closed to provide access to interior 20. Floor 16 and lid 18 include ports 20 and 22. Each of ports 20 and 22 has a door or other suitable closure (not shown) that can be opened and closed on demand. Proppant contents are dispensed through port 20 when the door of floor 16 is opened. Container 10 can be filled with proppant content by opening lid 18 (as shown) or through port 22 when lid 18 is closed. A problem with the design of container 10 is that residual proppant 24 remains in the lower corners when container 18 is emptied through port 20. Either the residual proppant is unused, wasting the expense of storing and shipping the material, or extra labor involving more expense is needed to more completely empty container 10. Given the weight of proppants, the volume used, the number of containers used in the course of a project, and the large size of the containers, the extra expense is significant.

FIG. 2 shows another conventional container 30 designed to avoid the problem of residual proppant remaining in the lower corners of the container. Container 30 includes rigid body 32 having sides 34 and floor 36. A lid 38 can be opened and closed to provide access to interior 40. Floor 36 and lid 38 include ports 40 and 42. Each of ports 40 and 42 has a door or other suitable closure (not shown) that can be opened and closed on demand. Proppant contents are dispensed through floor 36 when the door of floor 36 is opened. Container 30 can be filled with proppant content by opening lid 38 (as shown) or through port 42 when lid 38 is closed. As an additional feature, container 30 includes rigid cone 44 that provides a hopper function to dispense proppant contents from container 30 without leaving residual proppant in lower corners. A problem with the design of container 30 is that substantial space 46 is wasted. To store and dispense the same volume of proppant as the design in FIG. 1, container 30 must be substantially larger in size adding significantly to the costs to manufacture, ship, store, and use the containers.

The oilfield industry has a strong need for improved container systems for storing, shipping, and dispensing proppant materials used in hydraulic fracturing operations.

### SUMMARY OF THE INVENTION

The present invention provides improved container systems for storing, shipping, and dispensing proppant materials used in hydraulic fracturing operations. Container systems of the present invention incorporate stretchable hopper structures into a container. The hopper expands and contracts responsive to the amount of proppant material held by the container. When filled with a sufficient amount of proppant, the hopper stretches to expand the storage volume for holding proppant material. When sufficient proppant material is dispensed from the container, the hopper contracts to lift and dispense container contents that otherwise might get trapped in container corners.

Thus, using a stretchable hopper rather than a rigid cone to provide a hopper function allows for greater storage capacity within the same overall volume. Using the stretchable hopper also makes it easier to fully dispense the full amount of proppant material in a storage volume compared to boxes with no cone. Container systems of the present invention provide the advantages of both boxes with rigid cones and boxes without cones but without their respective disadvantages. The container systems also are compatible with intermodal transport. The containers may be transported using rail cars, trucks, ships, container handling centers, etc.

In one aspect, the present invention relates to a container system for one or more hydraulic fracturing proppants, said container system comprising:
(a) an expandable and contractable interior storage volume that holds one or more hydraulic fracturing proppants, said interior storage volume expanding and contracting responsive to an amount of the one or more proppants held in the storage volume; and
(b) a stretchable hopper defining at least a portion of the interior storage volume.

In another aspect, the present invention relates to a method of handling hydraulic fracturing proppants, comprising the steps of:
(a) providing a container system according to claim 1; and
(b) at least partially filling the interior storage volume with one or more hydraulic fracturing proppants in a manner such that the stretchable hopper expands to increase the interior storage volume.

In another aspect, the present invention relates to a method of handling hydraulic fracturing proppants, comprising the steps of:
(a) providing a container system according to claim 1, wherein the interior storage volume holds a sufficient amount of one or more proppants such that the stretchable hopper is in an expanded state; and
(b) dispensing a sufficient amount of the one or more proppants such that the stretchable hopper contracts to form a cone shape that lifts and helps to dispense at least a portion of the one or more proppants from the interior storage volume.

In another aspect, the present invention relates to a container system for one or more hydraulic fracturing proppants, said container system comprising:
(a) a support;
(b) a stretchable membrane coupled to the support in a manner effective to define at least a portion of a changeable storage volume, the size of the storage volume changing responsive to the amount of the one or more proppants held in the storage volume,
(c) an outlet fluidly coupled to the storage volume in a manner so that the one or more proppants can be dispensed from the storage volume through the outlet on demand; and wherein:
   i. the membrane expands to increase the storage volume as the storage volume is filled with more of the one or more proppants; and
   ii. the membrane contracts to decrease the storage volume as the storage volume is emptied of the one or more proppants, said membrane contraction causing the storage volume to have an inverted, truncated cone-shape that converges towards the outlet to facilitate dispensing the one or more proppants from the storage volume through the outlet.

In another aspect, the present invention relates to a container system for one or more hydraulic fracturing proppants, said container system comprising:
a) a housing having an interior volume;
b) a stretchable membrane coupled to the housing in a manner effective to define at least a portion of a changeable storage volume, wherein the membrane stretches and contracts to change the size of the storage volume responsive to the amount of the one or more proppants held in the storage volume;
c) an outlet fluidly coupled to the storage volume in a manner so that the one or more proppants can be dispensed from the storage volume through the outlet on demand; and
d) wherein, when the amount of the one or more proppants held in the storage volume is sufficiently low, the membrane has a contracted state in which the storage volume has an inverted, truncated cone shape that converges towards the outlet to form a hopper that facilitates dispensing the one or more proppants from the storage volume through the outlet; and
wherein, when the amount of the one or more proppants held in the storage volume is sufficiently high, the membrane has a stretched state in which the membrane stretches sufficiently so that the one or more proppants held in the storage volume defined by the stretched membrane substantially fill the interior volume of the housing.

In another aspect, the present invention relates to a method of handling hydraulic fracturing proppants, comprising the steps of:
a) providing a container system according to any preceding claim, wherein the container system is substantially empty, the outlet is closed, and the stretchable membrane is in a contracted state in which the storage volume has an inverted, truncated cone shape that converges towards the outlet to form a hopper that facilitates dispensing the one or more proppants from the storage volume through the outlet when the outlet is opened; and
b) filling the container with at least one proppant, wherein the membrane stretches to increase the size of the storage volume as the storage volume is filled with the at least one proppant.

In another aspect, the present invention relates to a method of handling hydraulic fracturing proppants, comprising the steps of:
a) providing a container system according to any preceding claim, wherein the container system is substantially filled with at least one proppant, the outlet is closed, and the stretchable membrane is in a stretched state to hold the at least one proppant and wherein a housing supports at least a portion of the stretched membrane;
b) opening the outlet to allow the at least one proppant to be dispensed from the container system; and
c) dispensing the at least one proppant such that, when a sufficient amount of the proppant has been dispensed, the membrane contracts to cause the storage volume to have an inverted, truncated cone shape that converges towards the outlet to form a hopper that facilitates further dispensing the one or more proppants from the storage volume through the outlet.

In another aspect, the present invention relates to a method of handling hydraulic fracturing proppants, comprising the steps of:
a) providing a first container system according to any preceding claim, wherein the container system is substantially filled with at least one proppant, the outlet is closed, and the stretchable membrane is in a stretched state to hold the at least one proppant and wherein a housing supports at least a portion of the stretched membrane;
b) stacking the first container system on a second container system according to any preceding claim, wherein the outlet of the first container is coupled to an inlet of the second container system;
c) dispensing the at least one proppant from the first container system into the second container system; and
d) further dispensing the at least one proppant from the second container system.

In another aspect, the present invention relates to a method of handling hydraulic fracturing proppants, comprising the steps of:
a) providing a first container system according to any preceding claim, wherein the first container systems is substantially filled with a first proppant content, wherein the stretchable membrane in the first container system is in a stretched state and wherein a housing supports at least a portion of the stretched membrane;
b) providing a second container system according to any preceding claim, wherein the second container systems is substantially filled with a second proppant content, wherein the stretchable membrane in the second container system is in a stretched state and wherein a housing supports at least a portion of the stretched membrane;
c) stacking the first container system on the second container system, wherein the outlet of the first container is coupled to an inlet of the second container system;
d) dispensing the second proppant content from the second container system;
e) dispensing the first proppant content from the first container system into the second container system; and
f) dispensing the first proppant content from the second container system.

### BRIEF DESCRIPTION OF THE DRAWINGS

FIG. 1 schematically shows a prior art container used to store hydraulic fracturing proppants.

FIG. 2 schematically shows an alternative prior art container used to store hydraulic fracturing components.

FIG. 3 shows a perspective view of a container system of the present invention.

FIG. 4 shows an exploded perspective view of the container system of FIG. 3.

FIG. 5 shows a perspective side view of a structural frame used in the container system of FIG. 3.

FIG. 6 shows a top view looking down into a box used in the container system of FIG. 3.

FIG. 7 schematically shows a perspective wireframe view of a stretchable hopper used in the container system of FIG. 3.

FIG. 8 shows a top view of an assembly in which the box of FIG. 6 is installed in the frame of FIG. 5, with the walls of the box schematically shown as being partially transparent to allow the frame to be seen through the box.

FIG. 9 schematically shows a lower gate assembly that can be used as a closure for the box of FIG. 6.

FIG. 10 schematically shows a side cross section view of the container system of

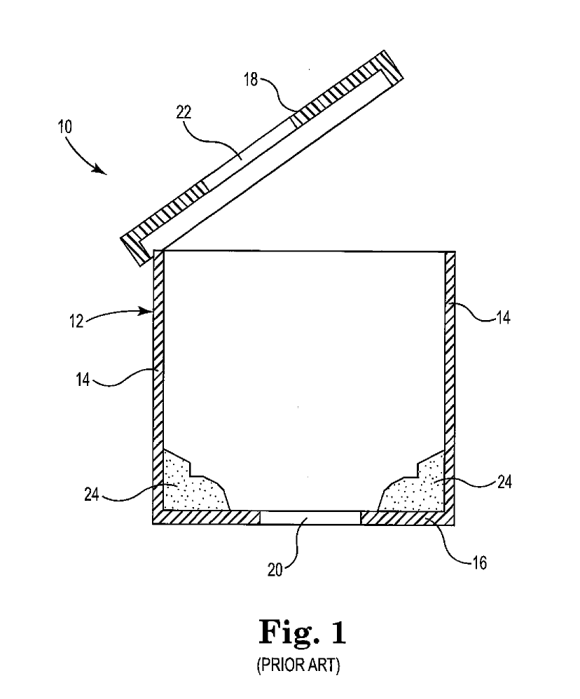

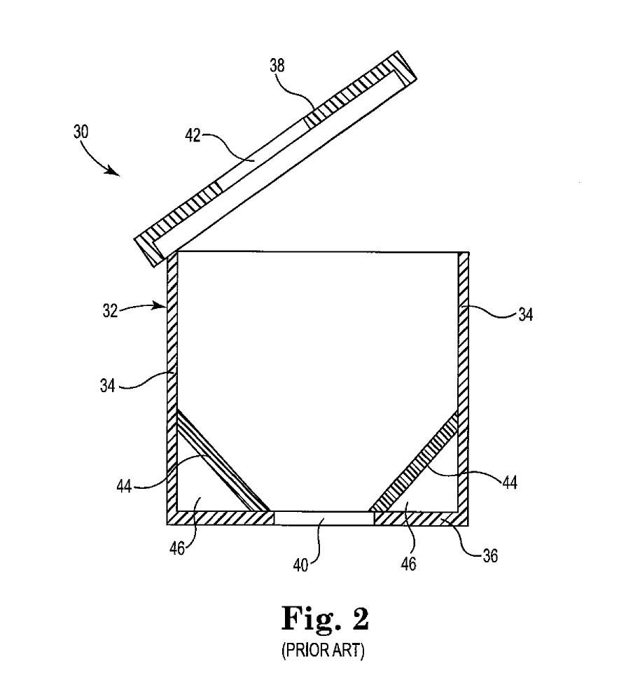

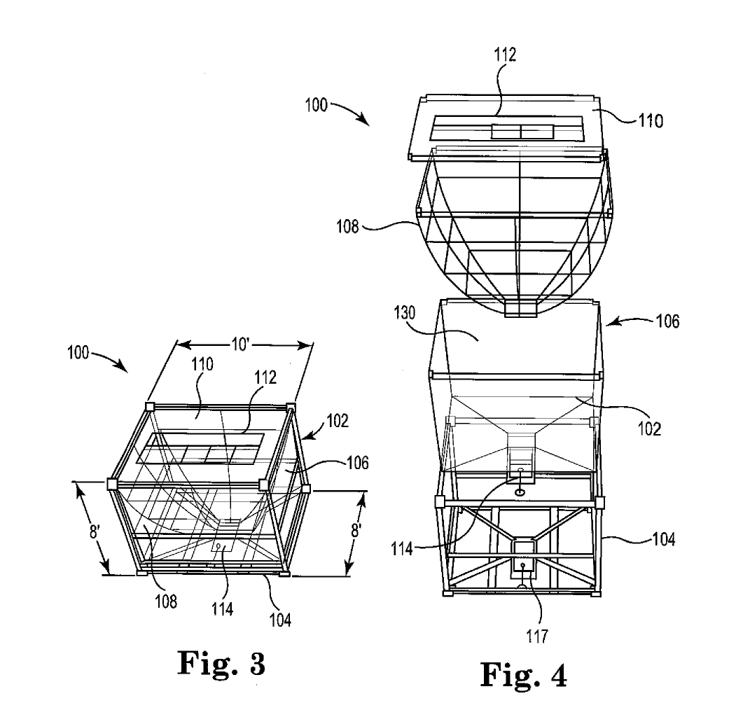

FIG. 3 in which the container system is empty and the stretchable hopper is in a contracted state in which the hopper has a truncated cone shape.

FIG. 11 schematically shows a side cross section view of the container system of FIG. 3 in which the container system is full of proppant material and the hopper has expanded to allow the proppant material to fill the container system.

FIG. 12 schematically shows a side cross section view of the container system of FIG. 3 in which the container system has been partially emptied but still includes a sufficient amount of proppant material so that the hopper is in a fully expanded state.

FIG. 13 schematically shows a side cross section view of the container system of FIG. 3 in which the container system has been emptied sufficiently so that the hopper is contracted to form a cone shape to lift and dispense remaining proppant material.

FIG. 14 is a perspective view of a structural frame, box, stretchable hopper, and lid assembly used in the container system of FIG. 3.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

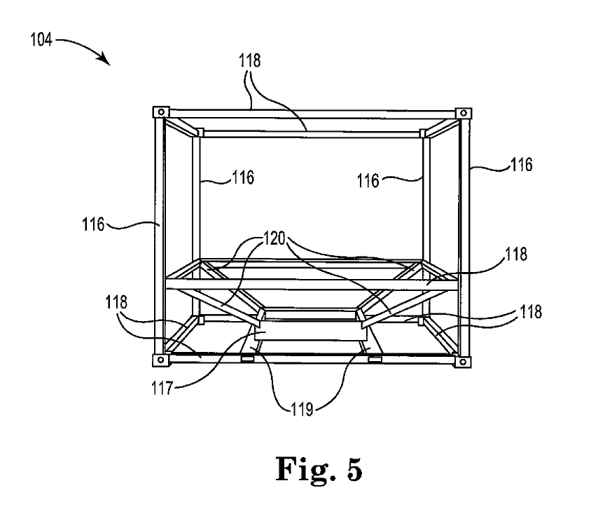

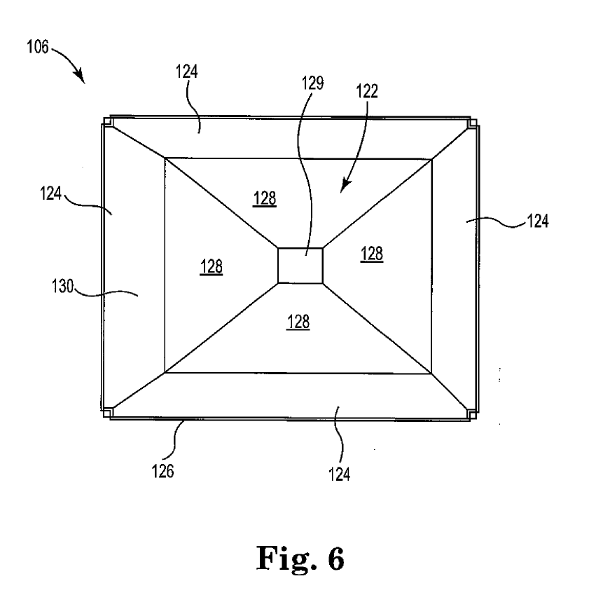

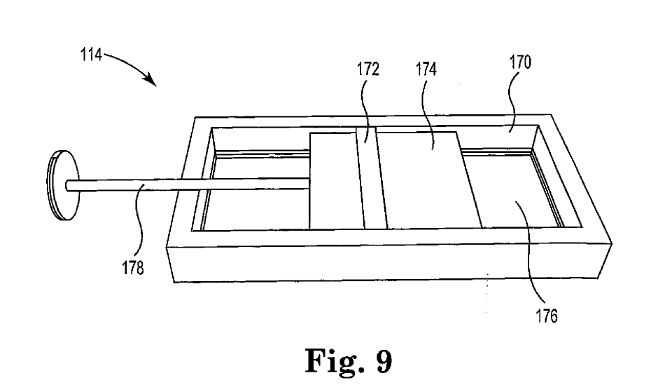

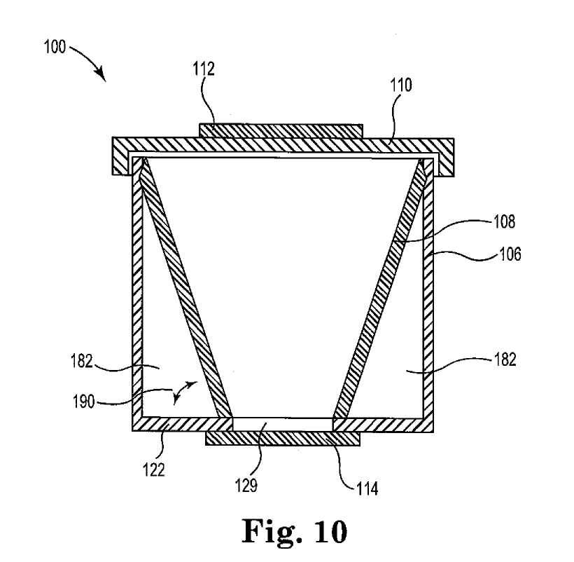

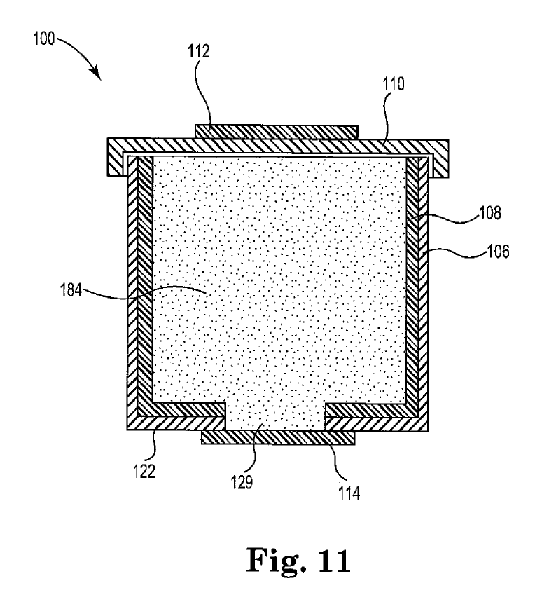

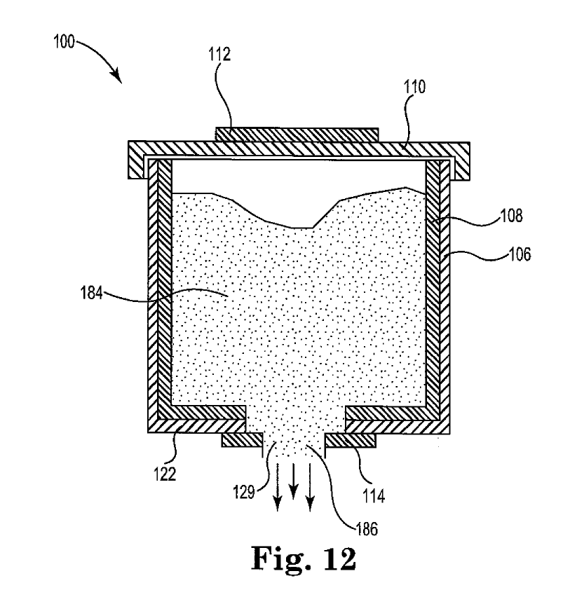

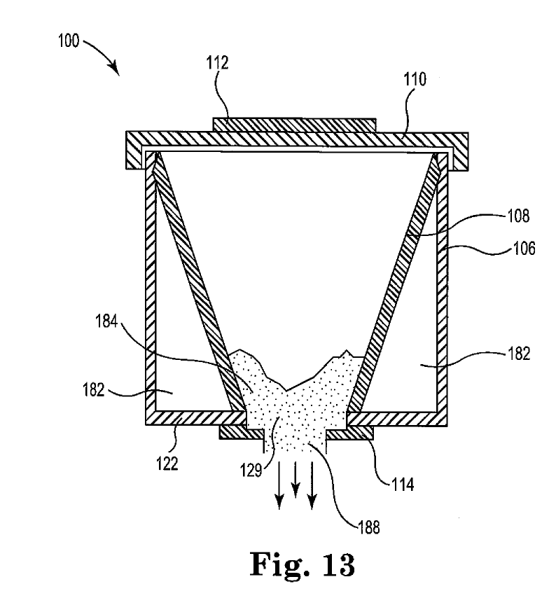

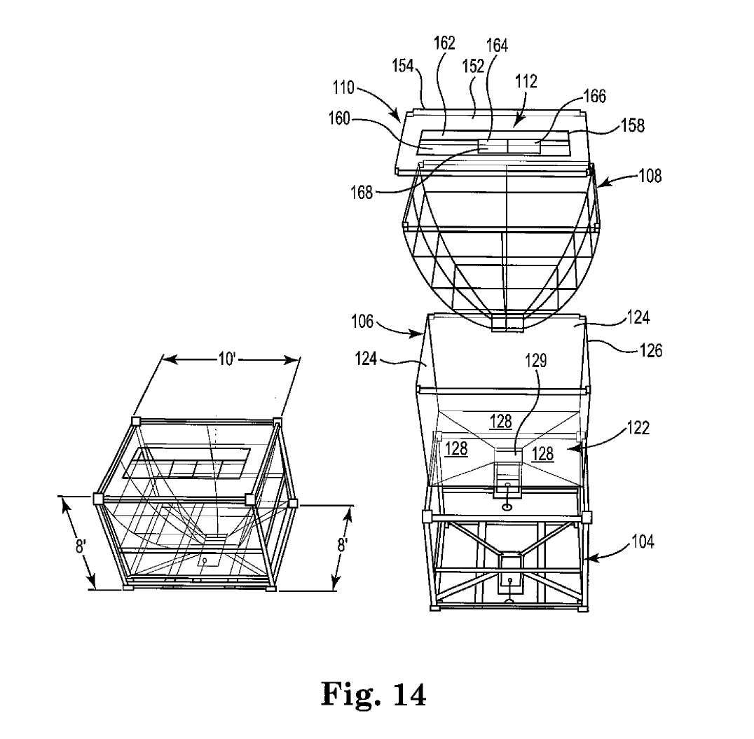

An illustrative embodiment of a container system 100 of the present invention is shown in FIGS. 3 to 14. Container system 100 is useful for storing, shipping, and dispensing one or more hydraulic fracturing proppants. As main components, system 100 includes a housing 102 formed by structural frame 104 and box 106. Container system 100 further includes; stretchable hopper 108; lid assembly 110 incorporating a first gate assembly 112; and a lower gate assembly 114. Structural frame 104 holds box 106 and optionally can serve as a support for mounting lower gate assembly 114. In some embodiments, lower gate assembly also could be mounted to box 106 or to both frame 104 and box 106. Structural frame 104 can have a variety of shapes to correspond to the shape of box 106. Exemplary shapes for frame 104 and box 106 include substantially cube-shaped or another rectilinear shape, cylindrical, cone and truncated cone shapes (including pyramids), combinations of these, or the like. As shown, structural frame 104 is substantially cube-shaped to match the box 106, except that the bottoms of frame 104 and box 106 are slightly coned. The shallow cone shape is too shallow to function optimally on its own as a hopper to easily help empty the contents (See FIGS. 10-13) of container system 100. However, the cone shaped bottoms nonetheless are beneficial to add substantial strength and rigidity. In the practice of the present invention, stretchable hopper 108 more effectively provides a hopper function as described below.

The sides of structural frame 104 are formed from vertical stiles 116 and horizontal rails 118. The bottom of frame 104 is formed by cross members 119, truss members 120, and gate frame 117 configured so that the bottom has a shallow cone shape that corresponds to a similar shallow cone shape on box 106. The various stiles 116, rails 118, cross members 119, truss members 120, and gate frame 117 may be integrally formed as single components or may be individual components that are coupled together using any suitable coupling techniques such as welding, bolting, lashing, screwing, gluing, snap fit engagement, combinations of these, and the like. The components of frame 104 may be made from a wide variety of materials including steel or other metallic compositions, polymer(s), polymer composites (such as fiberglass composites, pultruded composites, long fiber reinforced extruded composites, wood, and man-made cellulosic products), combinations of these, and the like. In some modes of practice, industry standards (e.g., ISO standards or the like) may be applicable, and structural frame 104 desirably would be configured to meet such standards.

Gate frame 117 helps to support lower gate assembly 114, wherein gate assembly 114 is coupled both to box 106 and gate frame 117 in this embodiment. In such modes of practice, components such as truss members 120 and/or frame 117 may include features to help hold, secure, and/or support the gate assembly 114.

Container system 100 is stackable for storage and shipping. Features of container system 100 also allow stacked containers to be filled and emptied on demand while stacked. For example, with gates appropriately opened, stacked containers can be filled with, e.g., sand and/or other proppant material. The sand can be poured or otherwise introduced into a top container of the stack, and the sand will fill all containers in the stack. Gates can be closed to seal the containers after the desired filling is completed. At a point of use, the gates can be opened so that the sand and/or other proppant material can be dispensed from all or some containers in a stack. Container systems of the present invention thus can be stacked like a silo, with proppant material flowing downward through the stack from one container to another either for filling the stack with proppant material or dispensing proppant material from the stack.

As illustrated, box 106 is schematically shown as being partially transparent so other components of system 100 can be viewed through box 106. In practice, box 106 may be opaque, transparent and/or partially transparent depending on material(s) used to form box 106. Box 106 helps to define a storage volume 121 to hold, ship, process, treat, dispense or otherwise handle or use one or more hydraulic fracturing proppant materials (see FIGS. 10 to 13). Box 106 also helps to support stretchable hopper 108 when box 106 is filled with proppant material. In many embodiments, stretchable hopper 108 is mounted to box 106 by suitable mounting features (not shown) such as one or more clamp, snap fit, lashing, bolts, screws, cord, welds, adhesive, combinations of these, and the like. In some other embodiments, stretchable hopper 108 is attached to frame 104. In other embodiments, stretchable hopper 108 may be secured to more than one other component such as being secured to both frame 104 and box 106.

Box 106 may have any suitable shape. Exemplary shapes are cylindrical, conical (including pyramids), cubic or other rectilinear shape. Box 106 as shown is substantially cubic in shape with a bottom 122 having a shallow cone shape for strength and rigidity. In addition to bottom 122, box 106 includes sides 124 and top rim 126. Top rim 126 defines aperture 130 through which proppant material can be loaded into storage volume 121 directly with lid assembly 110 raised, through opened gate assembly 112, or the like. Bottom 122 includes facets 128 to form the shallow cone shape for rigidity and strength. The shallow cone shape also makes cleaning easier as cleaning and rinsing liquids more easily drain from the sloped facets 128. Bottom 122 has aperture 129 through which box contents can be dispensed.

The components of box 106 may be provided in several ways as desired. In some instances, box 106 is integrally formed as a single item via a suitable molding or other fabrication process. Alternatively, box 106 components can be fabricated as separate parts that are then assembled via welds, glue, bolts, lashing, screws, nails, pins, rivets, snap fit, combinations of these, or the like.

Box 106 may be formed from a wide range of materials. Exemplary materials include steel or other metal composition(s), one or more polymers (e.g., high density polyethylene), fiber reinforced polymer materials, wood, synthetic cellulosic material (e.g., plywood or other composite cellulosic sheet goods), synthetic lumber, combinations of these and the like. One or more components of box 106 optionally may be reinforced with fiberglass, carbon fiber, polyaramid fabric, reinforcing fibers, meshes, organic and/or inorganic particles, and the like. One or more components of box 106 also may include one or more additives to help facilitate manufacture and/or enhance performance and service life. Exemplary additives include antistatic agents, biocides, fungicides, coloring agents, UV protecting agents, antioxidants, fillers, and the like.

Box 106 may have a wide range of sizes. Desirably, box 106 has a size so that container system 10 can be transported via truck transport, shipping, rail, and or combinations of these. In exemplary embodiments, each of the height, depth, and width of box 106 independently is in the range from 1 foot to 40 feet, preferably 5 to 15 feet, more preferably 5 to 10 feet.

FIGS. 3, 4, and 7 schematically show stretchable hopper 108 in wireframe, but in actual practice stretchable hopper 108 is sufficiently non-permeable so as to help hold and dispense proppants held within hopper 108. Stretchable hopper 108 has a first state in which hopper 108 is in the form of a truncated cone have one or more sides 134, top rim 136, and bottom rim 138. Preferably hopper 108 has a frustrum shape so that top rim 136 and bottom rim 138 are parallel, although this is not required in all embodiments. As used herein, a cone shape generally refers to a shape having a first end and a second end, wherein the cross-sectional area of the shape gradually tapers from the first end towards the second end. The taper can be linear, convex, concave, undulating, combinations of these, or the like. The cross sections at the first and second ends and intermediate between these ends independently may be circular, oval, triangular, square or other polygonal shape, or any other suitable shape.

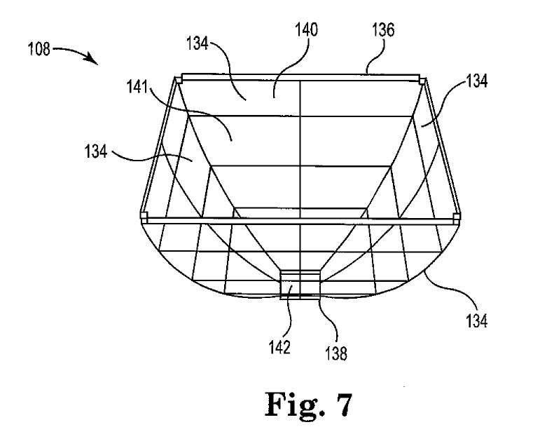

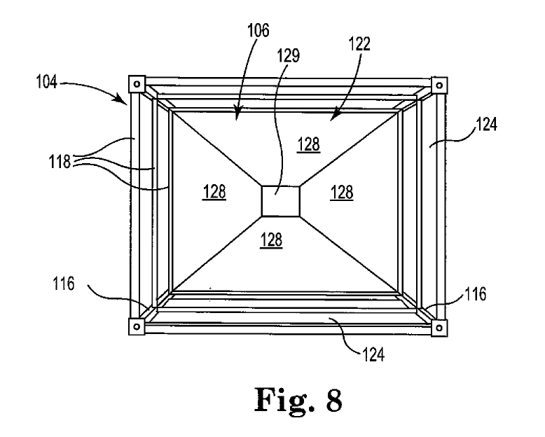

As shown, each of top rim 136 and bottom rim 138 defines a generally square cross section. Top rim 136 defines a relatively large first end, while bottom rim 138 defines a relatively smaller second end. The sides 134 of hopper 108 gradually taper from top rim 136 to bottom rim 138. The taper is shown in FIGS. 4 and 7 as being slightly convex when viewed from the exterior of hopper 108. However, when installed in container system 100, hopper 108 may be in tension so that the taper is linear. Such tension can help hopper 108 better support last portions of proppant being dispensed than if hopper 108 were slack at such time.

Top rim 136 defines a top opening 140 at the top of hopper 108, while bottom rim 138 defines a bottom opening 142 at the bottom of hopper 108. Bottom rim 138 is coupled to lower gate assembly 114 to facilitate dispensing proppant from storage volume 121 when lower gate assembly 114 is opened. Top rim 136 is in fluid communication with top gate assembly 112 and aperture 130 to allow storage volume 141 inside hopper 108 to be filled with proppant through top gate assembly 112 and/or aperture 130.

Stretchable hopper 108 is in the first, relatively contracted state when container system 10 is empty or when sufficient proppant contents have been dispensed from container system 10. In this state, hopper 108 has a truncated cone shape. Hopper 108 increasingly stretches as hopper 108 is filled with proppant, allowing substantially the entire volume of box 106 to be used to hold proppant. In this stretched shape, hopper 108 has a shape that more closely matches the contours of box 108. As hopper 108 is sufficiently emptied, hopper 108 returns to the truncated cone shape to provide a hopper function to facilitate emptying substantially all proppant contents from hopper 108. In other words, the stretchable hopper 108 stretches to occupy a greater volume of box 106 to increase storage volume when hopper 108 is filled with one or more proppants. Hopper 108 contracts to return to the hopper state when the amount of one or more proppants held in hopper 108 is sufficiently low. As the hopper 108 contracts as hopper 108 is emptied, the contraction causes hopper 108 to return to its inverted, truncated cone shape that converges from top rim 136 to bottom rim 138. The cone helps to empty substantially all of the proppant contents, even the material that had been stored in the corners of the stretched hopper 108.

Using a stretchable hopper 108 rather than a rigid cone allows for greater storage capacity within the same overall volume. Using the stretchable hopper 108 also makes it easier to fully dispense greater proportions of proppant material from container system 100 compared to boxes with no cone. Container system 100 of the present invention thus provides the advantages of boxes with rigid cones and boxes without cones but without their respective disadvantages. The function of container system 100 is described in more detail below with respect to FIGS. 10 through 13.

Hopper 108 incorporates a stretchable membrane material to help provide the ability of hopper 108 to repeatedly expand from and return to its first state in which hopper 108 has a truncated cone shape. Examples of such materials include thermoplastic and/or thermo set neoprene, natural and/or vulcanized rubber (e.g., including polyisoprene), polyurethane-polyurea copolymers, polybutadiene, polyisobutylene, polyurethane, polyester, combinations of these, and the like.

Neoprene elastomers are preferred. Membranes formed from materials including at least neoprene tend to be rugged and easy to clean. Neoprene as used herein refers to polychloreprene polymers and/or copolymers that incorporate 2-chlorobutadiene and optionally one or more other co-polymerizable constituents. Neoprene membranes can be selectively vulcanized to toughen up selected portions of the membrane such as at the bottom proximal to bottom rim 138 and/or at other stress points such as where the membrane is secured to the frame 104, box 106, and/or another portion of container system 100.

In addition to or as an alternative to vulcanization, stretchable hopper 108 optionally may incorporate reinforcing components. Examples include a stretchable mesh integrated on and/or in the membrane, reinforcing fibers, organic or inorganic fibers, combinations of these, or the like.

Lid assembly 110 includes plate 152 with reinforcing frame 154 around the perimeter. Lid assembly 110 desirably is mounted to structural frame 104 or box 106 on hinges (not shown) or the like so that lid assembly 110 can be raised or lowered. Lid assembly 110 may be opened to service or maintain system 100 and/or to fill hopper 108 with one or more proppants. One or more latches (not shown) or other securement components can be used to secure lid assembly 110 in a closed position. Gate assembly 112 fits and is mounted to plate 152 around central opening 156.

Gate assembly 112 includes large sliding door 160 that slides within frame 158. Door 160 can be opened to provide one aperture 162 through which storage hopper 108 can be filled with one or more proppants. Door 160 can be closed to seal the contents. Aperture 162 is a large, elongate opening. Container system 100 can be placed on a moving conveyor while being filled with proppant material. The long axis of aperture 162 can be aligned with direction of movement as container moves on the conveyor to provide a suitable window of time during which filling can occur. In other modes of practice, container system 100 can be stationary while being filled.

Door 160 includes a frame 164 on which smaller door 166 slides open to provide another, smaller aperture 168 through which hopper 108 can be filled with one or more proppants. Door 166 can be closed to seal the contents. The small door 166 provides an opportunity to attach equipment to fill hopper 108 via one or more nozzles or the like. The small door 166 also facilitates silo functions when multiple container systems 100 are stacked. When containers are stacked, small door 166 may be opened and then fluidly coupled to a lower gate assembly on the container above. This allows proppant material to drain from one stacked container to the one(s) below.

Lower gate assembly 114 includes frame 170, cross member 172, sliding door 174 that slides back and forth on frame 170, aperture 176 that is created when door 174 is opened, and actuating device 178.

Doors 160, 166, and 174 independently can be actuated manually or by automation, e.g., by hydraulic action. Gate assemblies 112 and 114 desirably includes features so that doors 160, 166, and 174 can be sealed tight to help contain liquids (if any) included with the proppant material. The seals desirably also are weather resistant to protect the proppant contents from the environment. In some modes of practice, ceramic seals are used as these seal tightly to provide liquid tight closures and can tolerate the abrasive character of proppant materials such as sand.

FIGS. 10 through 13 schematically show one way in which container system 100 can be used to handle proppant material. FIG. 10 schematically shows a cross section of container system 100 in which hopper 108 is empty and lid assembly 110 is closed. Without the weight of proppant material or other force, stretchable hopper 108 is in a first state in which hopper 108 has a truncated cone shape with the widest part of the cone at the top of box 106 and the narrowest part of the cone at the bottom of box 106. For schematic purposes, box 106 is shown without floor 122 having a moderate cone shape. The hopper 108 converges towards gate assembly 114. Zone 182 is between hopper 108 and box 106. If hopper 108 were rigid, the volume associated with zone 182 could not be used to store proppant material. If no hopper 108 were present, the zone 182 could be filled with proppant material, but zone 182 would be difficult to empty through lower gate assembly 114.

Hopper 108 has a cone angle 190. Hopper 108 may have a wide range of cone angles 190. If cone angle 190 is too shallow, however, the hopper 108 may be less effective at helping to dispense proppant material as described in FIGS. 11-13. If cone angle 190 is too steep, hopper 108 may not stretch as effectively as shown in FIG. 11. Accordingly, certain ranges of cone angles 190 may be more preferred to enhance performance. In some modes of practice, therefore, cone angle 190 is in a range from 20 degrees to 70 degrees, preferably 30 degrees to 50 degrees, more preferably 35 degrees to 45 degrees. By way of example, cone angles of 35 degrees and 41 degrees would be suitable.

FIG. 11 schematically shows a cross section of container system 100 in which hopper 108 is filled with proppant material 184. The weight of the proppant material stretches hopper 108 substantially to the full extent allowed by the walls of box 106. Hopper 108 has expanded to increase its storage volume as the hopper 108 is filled with proppant material 184. Even zones 182 (see FIG. 10) are filled with proppant material 184. A rigid cone could not allow the storage volume inside hopper 108 to be expanded in this manner. Hopper 108 is in a stretched state so that the proppant material 184 substantially fills the entire interior volume of box 106. Box 106 and structural frame 104 (not shown in FIGS. 10-13) support stretched hopper 108. Lid assembly 110 and gate assemblies 112 and 114 are sealed to protect the contents of the filled box 106 from the environment. In this state, container system 100 can be stored, stacked, transported, or otherwise handled.

FIG. 12 schematically shows a cross section of container system 100 in which a portion 186 of proppant material 184 is being dispensed through opened lower gate assembly 114. The proppant can be used in a variety of ways. In some illustrative modes of practice, proppant material 184 is dispensed directly at a point of use. In other modes of practice, proppant material can be dispensed onto a conveyor (not shown) and then conveyed to another location for further handling. In other modes of practice, container system 100 can be stacked on top of one or more other containers, so that the proppant material 184 is dispensed into one or more other containers. A substantial amount of proppant material 184 remains in hopper 108 so that hopper 108 is still substantially in the same fully stretched state as in FIG. 11.

FIG. 13 schematically shows a cross section of container system 100 in which additional portions 188 of proppant material 184 have been dispensed through lower gate assembly 114. More proppant material has been dispensed. The amount of proppant material 184 remaining in hopper 108 is sufficiently low so that hopper 108 has contracted from the fully stretched state in FIGS. 11 and 12. In the contracted state, hopper 108 returns to having a truncated cone geometry that converges toward gate assembly 114 to facilitate dispensing proppant material 184. The contraction of hopper 108 lifts proppant material out of zone 182, to allow material from those zones to more easily dispense than if no cone were to be present. After proppant material 184 is full_{y} dispensed from storage hopper 108, hopper 108 is sufficiently empty so that the emptied container system 100 is again in the state shown in FIG. 10. It can be seen therefore that the hopper 108 stretches to expand its storage volume and contracts to form a hopper responsive to the amount of proppant material in hopper 108. The expansion and contraction of hopper 108 exploits the potential energy in the proppant material and in the stretched hopper 108 to help control the geometry of hopper 108.

In an illustrative experiment, a wood box was made that was about 3 feet wide by about 3 feet deep by about 3 feet tall. A gate was coupled to the bottom of the box. The gate could be opened and closed. A stretchable membrane in the shape of a cone and made from neoprene sheeting was installed in the box. The top, larger end of the membrane was attached to the top rim of the box. The bottom, smaller end of the membrane was attached to the bottom gate. The membrane tapered from the top toward the gate at a cone angle of about 35 to 41 degrees. The box was filled with sand. As the sand filled the box, the membrane expanded until substantially the entire interior of the box was filled with sand. The box supported the expanded membrane. The gate at the bottom was opened to drain the sand from the box. When the amount of sand was sufficiently low, the membrane contracted and returned to having a cone shape. This helped to lift sound out of the bottom corners of the box and drain the sand through the open gate. Substantially all of the sand was drained from the box.

All patents, patent applications, and publications cited herein are incorporated by reference as if individually incorporated. Unless otherwise indicated, all parts and percentages are by weight and all molecular weights are number average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A container system for one or more hydraulic fracturing proppants, said container system comprising:
(a) an expandable and contractable interior storage volume that holds one or more hydraulic fracturing proppants, said interior storage volume expanding and contracting responsive to an amount of the one or more proppants held in the storage volume; and
(b) a stretchable hopper defining at least a portion of the interior storage volume.

2. A method of handling hydraulic fracturing proppants, comprising the steps of:
(a) providing a container system according to claim 1; and
(b) at least partially filling the interior storage volume with one or more hydraulic fracturing proppants in a manner such that the stretchable hopper expands to increase the interior storage volume.

3. A method of handling hydraulic fracturing proppants, comprising the steps of:
(a) providing a container system according to claim 1, wherein the interior storage volume holds a sufficient amount of one or more proppants such that the stretchable hopper is in an expanded state; and
(b) dispensing a sufficient amount of the one or more proppants such that the stretchable hopper contracts to form a cone shape that lifts and helps to dispense at least a portion of the one or more proppants from the interior storage volume.

4. A container system for one or more hydraulic fracturing proppants, said container system comprising:
(a) a support;
(b) a stretchable membrane coupled to the support in a manner effective to define at least a portion of a changeable storage volume, the size of the storage volume changing responsive to the amount of the one or more proppants held in the storage volume,
(c) an outlet fluidly coupled to the storage volume in a manner so that the one or more proppants can be dispensed from the storage volume through the outlet on demand; and wherein:
i. the membrane expands to increase the storage volume as the storage volume is filled with more of the one or more proppants; and
ii. the membrane contracts to decrease the storage volume as the storage volume is emptied of the one or more proppants, said membrane contraction causing the storage volume to have an inverted, truncated cone-shape that converges towards the outlet to facilitate dispensing the one or more proppants from the storage volume through the outlet.

5. A method of handling hydraulic fracturing proppants, comprising the steps of:
providing a container system according to claim 4, wherein the container system is substantially empty, the outlet is closed, and the stretchable membrane is in a contracted state in which the storage volume has an inverted, truncated cone shape that converges towards the outlet to form a hopper that facilitates dispensing the one or more proppants from the storage volume through the outlet when the outlet is opened; and
filling the container with at least one proppant, wherein the membrane stretches to increase the size of the storage volume as the storage volume is filled with the at least one proppant.

6. A method of handling hydraulic fracturing proppants, comprising the steps of:
providing a container system according to claim 4, wherein the container system is substantially filled with at least one proppant, the outlet is closed, and the stretchable membrane is in a stretched state to hold the at least one proppant and wherein a housing supports at least a portion of the stretched membrane;
opening the outlet to allow the at least one proppant to be dispensed from the container system; and
dispensing the at least one proppant such that, when a sufficient amount of the proppant has been dispensed, the membrane contracts to cause the storage volume to have an inverted, truncated cone shape that converges towards the outlet to form a hopper that facilitates further dispensing the one or more proppants from the storage volume through the outlet.

7. A method of handling hydraulic fracturing proppants, comprising the steps of:
providing a first container system according to claim 4, wherein the container system is substantially filled with at least one proppant, the outlet is closed, and the stretchable membrane is in a stretched state to hold the at least one proppant and wherein a housing supports at least a portion of the stretched membrane;
stacking the first container system on a second container system according to any preceding claim, wherein the outlet of the first container is coupled to an inlet of the second container system;
dispensing the at least one proppant from the first container system into the second container system; and
further dispensing the at least one proppant from the second container system.

8. A method of handling hydraulic fracturing proppants, comprising the steps of:
providing a first container system according to claim 4, wherein the first container systems is substantially filled with a first proppant content, wherein the stretchable membrane in the first container system is in a stretched state and wherein a housing supports at least a portion of the stretched membrane;
providing a second container system according to any preceding claim, wherein the second container systems is substantially filled with a second proppant content, wherein the stretchable membrane in the second container system is in a stretched state and wherein a housing supports at least a portion of the stretched membrane;
stacking the first container system on the second container system, wherein the outlet of the first container is coupled to an inlet of the second container system;
dispensing the second proppant content from the second container system;
dispensing the first proppant content from the first container system into the second container system; and
dispensing the first proppant content from the second container system.

9. A container system for one or more hydraulic fracturing proppants, said container system comprising:
a housing having an interior volume;
a stretchable membrane coupled to the housing in a manner effective to define at least a portion of a changeable storage volume, wherein the membrane stretches and contracts to change the size of the storage volume responsive to the amount of the one or more proppants held in the storage volume;
an outlet fluidly coupled to the storage volume in a manner so that the one or more proppants can be dispensed from the storage volume through the outlet on demand; and
wherein, when the amount of the one or more proppants held in the storage volume is sufficiently low, the membrane has a contracted state in which the storage volume has an inverted, truncated cone shape that converges towards the outlet to form a hopper that facilitates dispensing the one or more proppants from the storage volume through the outlet; and
wherein, when the amount of the one or more proppants held in the storage volume is sufficiently high, the membrane has a stretched state in which the membrane stretches sufficiently so that the one or more proppants held in the storage volume defined by the stretched membrane substantially fill the interior volume of the housing.

10. A method of handling hydraulic fracturing proppants, comprising the steps of:
providing a container system according to claim 9, wherein the container system is substantially empty, the outlet is closed, and the stretchable membrane is in a contracted state in which the storage volume has an inverted, truncated cone shape that converges towards the outlet to form a hopper that facilitates dispensing the one or more proppants from the storage volume through the outlet when the outlet is opened; and
filling the container with at least one proppant, wherein the membrane stretches to increase the size of the storage volume as the storage volume is filled with the at least one proppant.

11. A method of handling hydraulic fracturing proppants, comprising the steps of:
providing a container system according to claim 9, wherein the container system is substantially filled with at least one proppant, the outlet is closed, and the stretchable membrane is in a stretched state to hold the at least one proppant and wherein a housing supports at least a portion of the stretched membrane;
opening the outlet to allow the at least one proppant to be dispensed from the container system; and
dispensing the at least one proppant such that, when a sufficient amount of the proppant has been dispensed, the membrane contracts to cause the storage volume to have an inverted, truncated cone shape that converges towards the outlet to form a hopper that facilitates further dispensing the one or more proppants from the storage volume through the outlet.

12. A method of handling hydraulic fracturing proppants, comprising the steps of:
providing a first container system according to claim 9, wherein the container system is substantially filled with at least one proppant, the outlet is closed, and the stretchable membrane is in a stretched state to hold the at least one proppant and wherein a housing supports at least a portion of the stretched membrane;
stacking the first container system on a second container system according to any preceding claim, wherein the outlet of the first container is coupled to an inlet of the second container system;
dispensing the at least one proppant from the first container system into the second container system; and
further dispensing the at least one proppant from the second container system.

13. A method of handling hydraulic fracturing proppants, comprising the steps of:
providing a first container system according to claim 9, wherein the first container systems is substantially filled with a first proppant content, wherein the stretchable membrane in the first container system is in a stretched state and wherein a housing supports at least a portion of the stretched membrane;
providing a second container system according to any preceding claim, wherein the second container systems is substantially filled with a second proppant content, wherein the stretchable membrane in the second container system is in a stretched state and wherein a housing supports at least a portion of the stretched membrane;
stacking the first container system on the second container system, wherein the outlet of the first container is coupled to an inlet of the second container system;
dispensing the second proppant content from the second container system;
dispensing the first proppant content from the first container system into the second container system; and
dispensing the first proppant content from the second container system.
